(19) United States
(12) Patent Application Publication
(10) Pub. No.: US 2023/0153324 A1
(43) Pub. Date: May 18, 2023

(54) SERVICE DISCOVERY METHOD AND APPARATUS, COMPUTING DEVICE, AND STORAGE MEDIUM

(71) Applicant: Beijing Tusen Zhitu Technology Co., Ltd., Beijing (CN)

(72) Inventors: Yifan GONG, Beijing (CN); Jiangming JIN, Beijing (CN)

(21) Appl. No.: 17/989,467

(22) Filed: Nov. 17, 2022

(30) Foreign Application Priority Data
Nov. 18, 2021 (CN) 202111370479.4

(51) Int. Cl. G06F 16/27; G06F 16/22; G06F 21/62

(52) U.S. Cl. CPC G06F 16/273; G06F 16/2272; G06F 21/6218

(57) ABSTRACT

The present disclosure provides a service discovery method and apparatus, a computing device, and a storage medium, to solve the problem of node data falsification or tampering easily occurring in the prior art. The service discovery method comprises: in response to discovering a target node to be online or offline, creating, by a first online node, a block of a target node, and sending a data synchronization request to a second online node; in response to determining that the block is the latest block, informing, by the second online node, a plurality of third online nodes to respectively authenticate the permission of the target node; and performing statistics on permission authentication results of the target node authenticated by the plurality of third online nodes, and synchronizing the block to a block chain respectively maintained by each online node in response to an authentication passing rate satisfying a predetermined condition.

This patent document claims priority to Chinese patent application No. 202111370479.4, titled “SERVICE DISCOVERY METHOD AND APPARATUS, COMPUTING DEVICE, AND STORAGE MEDIUM”, filed on Nov. 18, 2021, the content of which is incorporated herein by reference in its entirety.

### TECHNICAL FIELD

The present disclosure relates to the technical field of computers, in particular to a service discovery method and apparatus, a computing device, and a storage medium.

### BACKGROUND

Service discovery plays an important role in an automatic driving system, and it takes charge of online/offline management of each node in the system as well as maintenance and record of the state of the node. However, it is very difficult for an existing service discovery solution to ensure the safety of a service function, which mainly lies in that the situation that the nodes are cheated and the online/offline records of the nodes are falsified or tampered is not taken into account. For example, after some malice invaders falsify or tamper the online/offline records of the nodes, the nodes in the current system may be cheated, which may cause serious consequences, for example, the entire system breaks down or is controlled, and then, the safety of the automatic driving system may be severely affected.

### SUMMARY

Embodiments of the present disclosure provide a service discovery method and apparatus, a computing device, and a storage medium to improve the safety and accuracy of node service discovery.

In order to achieve the above-mentioned objectives, the embodiments of the present disclosure adopt the following technical solutions:

a first aspect of the embodiments of the present disclosure provides a service discovery method, including:

in response to discovering a target node to be online or offline, creating, by a first online node, a block of the target node, and sending a data synchronization request to a second online node;

in response to determining that the block is the latest block, informing, by a second online node, a plurality of third online nodes to respectively authenticate the permission of the target node; and

performing statistics on permission authentication results of the target node authenticated by the plurality of third online nodes, and synchronizing the block to block chains respectively maintained by the current online node in response to an authentication passing rate satisfies a predetermined condition.

A second aspect of the embodiments of the present disclosure provides a service discovery system, including:

a first online node configured to create a block of a target node in response to discovering a target node to be online or offline;

a second online node configured to, in response to a data synchronization request sent by the first online node, inform a plurality of third online nodes to respectively authenticate the permission of the target node in response to determining that the block is the latest block; and

a data updating module configured to perform statistics on permission authentication results of the target node authenticated by the plurality of third online nodes, and synchronize the block to block chains respectively maintained by the current online nodes if an authentication passing rate satisfies a predetermined condition.

A third aspect of the embodiments of the present disclosure provides a computing device, including a processor, a memory, and a computer program stored in the memory and runnable on the processor; wherein the processor, when running the computer program, implements the above-mentioned service discovery method.

A fourth aspect of the embodiments of the present disclosure provides a computer-readable storage medium storing a computer program, the computer program, when being run by a processor, implementing the above-mentioned service discovery method.

The technical solutions of the embodiments of the present disclosure provide a decentralized distributed system in which each node may be equipped with a database storing the same block chain data, the operation that each node is online or offline will be written into the database of each node, and online and offline data records of each node will be stored in the database in the way of the block chain. According to the present disclosure, the problem of data falsification or tampering is solved, and when the nodes are online or offline, the online/offline information can be written into the block chains only when the authentication passing rate satisfies the predetermined condition.

### BRIEF DESCRIPTION OF THE DRAWINGS

To describe the technical solutions in the embodiments of the present disclosure or the prior art more clearly, the accompanying drawings required for describing the embodiments or the prior art will be briefly introduced below. Apparently, the accompanying drawings in the following description show only some embodiments of the present disclosure, and the ordinary skill in the art may still derive other accompanying drawings from these accompanying drawings without creative efforts.

FIG. 1 is a structural diagram of a vehicle 100 according to an embodiment of the present disclosure;

FIG. 2 is a flow process of a service discovery method 200 according to an embodiment of the present disclosure;

FIG. 3 is a schematic structural diagram of a database according to an embodiment of the present disclosure;

FIG. 4 is a schematic content diagram of an online block according to an embodiment of the present disclosure;

FIG. 5 is a schematic content diagram of an offline block according to an embodiment of the present disclosure;

FIG. 6 is a flow process of a service discovery method 600 for a situation that a node is online in an embodiment of the present disclosure;

FIG. 7 is a flow process of a service discovery method 700 for a situation that a node is offline in an embodiment of the present disclosure;

FIG. 8 is a structural diagram of a service discovery apparatus 800 according to an embodiment of the present disclosure; and

FIG. 9 is a structural diagram of a computing device 900 according to an embodiment of the present disclosure.

### DETAILED DESCRIPTION

The technical solutions in the embodiments of the present disclosure will be described clearly and completely below in conjunction with the accompanying drawings in the embodiments of the present disclosure. Apparently, the described embodiments are a part of the embodiments of the present disclosure, not all the embodiments. Based on the embodiments of the present disclosure, all other embodiments obtained by those of ordinary skill in the art without creative work shall fall within the protective scope of the present disclosure.

It should be noted that terms such as “first” and “second” in the description and claims of the present disclosure and the above-mentioned accompanying drawings are used for distinguishing similar objects, but are unnecessarily used for describing a specific sequential or chronological order. It should be understood that data used in such a way are interchangeable under appropriate circumstances, such that the embodiments of the present disclosure described herein can be implemented. In addition, terms “including” and “having” and any variants thereof are intended to cover non-exclusive inclusion. For example, a process, method, system, product or device including a series of steps or units are unnecessarily limited to the clear listing of those steps or units, but may comprise other steps or units which are not clearly listed or are inherent for the process, method, product or device.

FIG. 1 is a structural diagram of a vehicle 100 in which various technologies disclosed herein maybe achieved. The vehicle 100 may be a car, a truck, a motorbike, a bus, a ship, an airplane, a helicopter, a mower, an excavator, a snowmobile, an aircraft, a recreational vehicle for a tourist, a vehicle for an amusement park, a farmland apparatus, a building apparatus, a streetcar, a golf cart, a train, a trolleybus, or other vehicles. The vehicle 100 may fully or partially run in an automatic driving mode. The vehicle 100 may control itself in the automatic driving mode, for example, the vehicle 100 may determine its current state and the current state of an environment where the vehicle is located, determine a predicted behavior of at least one of other vehicles in this environment, determine a confidence level corresponding to a possibility that the at least one of other vehicles performs the predicted behavior, and control the vehicle 100 itself on the basis of the determined information. When being in the automatic driving mode, the vehicle 100 may run without interaction.

The vehicle 100 may comprise various vehicle systems, e.g. a driving system 142, a sensor system 144, a control system 146, a user interface system 148, a control computer system 150, and a communication system 152. The vehicle 100 may comprise more or fewer systems, and each system may comprise a plurality of units. Further, each system and unit of the vehicle 100 may be interconnected. For example, the control computer system 150 may be in data communication with one or more of the vehicle systems 142-148 and 152. Thus, one or more of the described functions of the vehicle 100 may be divided into additional functional parts or entity parts or combined into functional parts or entity parts which are fewer in number. In a further example, the additional functional parts or entity parts may be increased to an example as shown in FIG. 1.

The driving system 142 may comprise a plurality of operational parts (or units) providing kinetic energy to the vehicle 100. In an embodiment, the driving system 142 may comprise an engine or electromotor, wheels, a speed changer, an electronic system, and power (or a power source). The engine or electromotor may be any combination of the following apparatuses: an internal combustion engine, a motor, a steam engine, a fuel cell engine, a propane engine, or other forms of engines or electromotors. In some embodiments, the engine may convert a power source into mechanical energy. In some embodiments, the driving system 142 may comprise various engines or electromotors. For example, a gasoline-electric hybrid vehicle may comprise a gasoline engine and an electromotor, and may also comprise other situations.

The wheels of the vehicle 100 may be standard wheels. The wheels of the vehicle 100 may be various forms of wheels, including a single-wheel, double-wheel, three-wheel or four-wheel form, e.g. four wheels on the car or truck. It is also possible to provide other numbers of wheels, e.g. six wheels or more wheels. One or more wheels of the vehicle 100 may be operated to rotate in a direction different from that of other wheels. The wheels may be at least one wheel fixedly connected to the speed changer. The wheels may comprise a combination of metal and rubber or a combination of other substances. The speed changer may comprise a unit which may be operated to transfer the mechanical power of the engine to the wheels. For this purpose, the speed changer may comprise a gearbox, a clutch, a differential gear, and a transmission shaft. The speed changer may also comprise other units. The transmission shaft may comprise one or more axles matched with the wheels. The electronic system may comprise units for transmitting or controlling electronic signals of the vehicle 100. These electronic signals may be used for starting a plurality of lamps, a plurality of servo mechanisms, a plurality of electromotors, and other electronic driving or control apparatuses in the vehicle 100. The power source may be an energy source fully or partially providing power to the engine or electromotor. That is, the engine or electromotor may convert the power source into the mechanical energy. Exemplarily, the power source may comprise gasoline, petroleum, petroleum fuel, propane, other compressed gas fuels, ethanol, fuel cells, solar panels, batteries, and other electric energy sources. The power source may additionally or optionally comprise any combination of a fuel tank, a battery, a capacitor, or flywheels. The power source may also provide energy for other systems of the vehicle 100.

The sensor system 144 may comprise a plurality of sensors, and these sensors are used for sensing information of the environment and condition of the vehicle 100. For example, the sensor system 144 may comprise an inertial measurement unit (IMU), a global positioning system (GPS) transceiver, a radar (RADAR) unit, a laser range finer/LIDAR unit (or other distance measurement apparatuses), an acoustic sensor, and a camera or an image capturing apparatus. The sensor system 144 may comprise a plurality of inductors (e.g. an oxygen (02) monitor, a fuel meter sensor, and an engine oil pressure sensor) for monitoring the vehicle 100. Other sensors may also be disposed. One or more sensors comprised in the sensor system 144 may be driven alone or integrally, so that the position or direction or the both of one or more sensors may be updated.

The IMU may comprise a combination of sensors (e.g. an accelerator and a gyroscope) and is used for sensing the positional and directional change of the vehicle 100 on the basis of inertial acceleration. The GPS transceiver may be any sensor used for estimating the geographic position of the vehicle 100. For this purpose, the GPS transceiver may comprise a receiver/transmitter so as to provide positional information of the vehicle 100 relative to the earth. It should be noted that a GPS is an example of a global navigational satellite system, and therefore, in some embodiments, the GPS transceiver may be replaced with a BeiDou satellite navigation system transceiver or Galileo satellite navigation system transceiver. The radar unit may sense, by using a radio signal, an object in the environment where the vehicle 100 is located. In some embodiments, in addition to the object, the radar unit may also be used for sensing the speed and advancing direction of an object close to the vehicle 100. The laser range finder/LIDAR unit (or other distance measurement apparatuses) may be any sensor sensing, by using laser, the object in the environment where the vehicle 100 is located. In an embodiment, the laser range finder/LIDAR unit may comprise a laser source, a laser scanner, and a detector. The laser range finder/LIDAR unit is used for working in a continuous (e.g. Using heterodyne detection) or discontinuous detection mode. The camera may be an apparatus for capturing a plurality of images of the environment where the vehicle 100 is located. The camera may be a static image camera or a dynamic image camera.

The control system 146 is used for controlling operation for the vehicle 100 and parts (units) thereof. Accordingly, the control system 146 may comprise various units, e.g. a steering unit, a power control unit, a braking unit, and a navigation unit.

The steering unit may be a combination of mechanisms adjusting the advancing direction of the vehicle 100. The power control unit (e.g. an accelerator), may be, for example, used for controlling the running speed of the engine, thereby controlling the speed of the vehicle 100. The braking unit may comprise a combination of mechanisms used for decelerating the vehicle 100. The braking unit may enable the vehicle to decelerate by means of a friction force in a standard way. In other embodiments, the braking unit may convert the kinetic energy of the wheels into a current. The braking unit may also be in other forms. The navigation unit may be any system determining a driving path or line for the vehicle 100. The navigation unit may also dynamically update the driving path in a process that the vehicle 100 advances. The control system 146 may additionally or optionally comprise other unshown or undescribed parts (or units).

The user interface system 148 may be used for allowing the interaction between the vehicle 100 and each of an external sensor, other vehicles, other computer systems and/or a user of the vehicle 100. For example, the user interface system 148 may comprise a standard visual display apparatus (e.g. a plasma display, a liquid crystal display (LCD), a touch screen display, a head-mounted display, or other similar displayers), a loudspeaker or other audio output apparatuses, a microphone or other audio input apparatuses. For example, the user interface system 148 may further comprise a navigation interface and an interface for controlling the internal environment (e.g. a temperature and a fan) of the vehicle 100.

The communication system 152 may provide a way for the vehicle 100 to be in communication with one or more devices or other surrounding vehicles. In an exemplary embodiment, the communication system 152 may be in communication with one or more devices directly or through a communication network. The communication system 152 may be, for example, a wireless communication system. For example, the communication system may achieve 3G cellular communication (e.g. CDMA, EVDO, and GSM/GPRS) or 4G cellular communication (e.g. WiMAX or LTE), and may also achieve 5G cellular communication. Optionally, the communication system may be in communication with a wireless local area network (WLAN) (e.g. WIFI®). In some embodiments, the communication system 152 may be in direct communication with one or more devices or other surrounding vehicles by using, for example, infrared rays, Bluetooth®, or ZIGBEE. Other wireless protocols, such as various vehicle-mounted communication systems, also fall within the scope of the present disclosure. For example, the communication system may comprise one or more dedicated short range communication (DSRC) apparatuses, V2V apparatuses or V2X apparatuses, and these apparatuses may be in public or private data communication with a vehicle and/or a roadside station.

The control computer system 150 may control parts or all of functions of the vehicle 100. An automatic driving control unit in the control computer system 150 may be used for recognizing, evaluating and avoiding or overstepping a potential obstacle in the environment where the vehicle 100 is located. Generally, the automatic driving control unit may be used for controlling the vehicle 100 without drivers or providing assistance for the drivers to control the vehicle. In some embodiments, the automatic driving control unit is used for combining data from the GPS transceiver, radar data, LIDAR data, camera data, and data from other vehicle systems to determine the driving path or track of the vehicle 100. The automatic driving control unit may be activated so that the vehicle 100 may be driven in an automatic driving mode.

The control computer system 150 may comprise at least one processor (which may comprise at least one microprocessor), and the processor executes processing instructions (i.e. machine-executable instructions) stored in a non-volatile computer-readable medium (e.g. a data storage apparatus or a memory). The memory stores at least one machine-executable instruction, and the processor executes the at least one machine-executable instruction to achieve functions including a map engine, a positioning module, a perception module, a navigation or path module, and an automatic control module, etc. The map engine and the positioning module are used for providing map information and positioning information. The perception module is used for perceiving, according to the information acquired by the sensor system and the map information provided by the map engine, an object in the environment wherein the vehicle is located. The navigation or path module is used for planning a driving path for the vehicle according to processing results from the map engine, the positioning module and the perception module. The automatic control module inputs, analyzes and converts decision-making information of the modules such as the navigation or path module into a control command for a vehicle control system to be output, and sends the control command to a corresponding part in the vehicle control system through a vehicle-mounted network (e.g. a CAN bus, a local area Internet, multimedia oriented system transmission, and other ways), thereby achieving automatic control on the vehicle; and the automatic control module may also acquire information of each part in the vehicle through the vehicle-mounted network.

The control computer system 150 may also be a plurality of computing apparatuses which distributively control the parts or system of the vehicle 100. In some embodiments, the memory may comprise processing instructions (e.g. program logics) executed by the processor to implement various functions of the vehicle 100. In an embodiment, the control computer system 150 may be in data communication with the systems 142, 144, 146, 148 and/or 152. An interface in the control computer system is used for promoting data communication between the control computer system 150 and each of the systems 142, 144, 146, 148 and/or 152.

The memory may further comprise other instructions including an instruction for data sending, an instruction for data reception, an instruction for interaction, or an instruction for the control driving system 140, the sensor system 144, or the control system 146, or the user interface system 148.

In addition to the storage of the processing instructions, the memory may store various information or data, e.g. an image processing parameter, a road map, and path information. When the vehicle 100 runs in an automatic mode, semi-automatic mode and/or manual mode, the information may be used by the vehicle 100 and the control computer system 150.

Although the automatic driving control unit is shown to be separated from the processor and the memory, it should be understood that, in some implementations, some or all of the functions of the automatic driving control unit may be implemented by program code instructions staying in one or more memories (or data storage apparatuses) and executed by one or more processor, and the automatic driving control unit may be implemented by using the same processor and/or memory (or data storage apparatuses) under some conditions. In some implementations, the automatic driving control unit may at least partially use various dedicated circuit logics, various processors, various field-programmable gate arrays (“FPGA”), various application-specific integrated circuits (“ASIC”), various real-time controllers, and hardware.

The control computer system 150 may control the functions of the vehicle 100 according to inputs received from various vehicle systems (e.g. the driving system 142, the sensor system 144, and the control system 146), or an input received from the user interface system 148. For example, the control computer system 150 may control the steering unit by using the input from the control system 146, thereby avoiding an obstacle detected by the sensor system 144. In an embodiment, the control computer system 150 may be used for controlling various aspects of the vehicle 100 and the systems thereof.

Although FIG. 1 shows the various parts (or units) integrated to the vehicle 100, one or more of these parts (or units) may be loaded on the vehicle 100 or associated to the vehicle 100 alone. For example, the control computer system may exist in a way of being partially or fully independent of the vehicle 100. Thus, the vehicle 100 may exist in a form of separate or integrated device units. Intercommunication may be achieved among the device units of the vehicle 100 in a wired or wireless communication way. In some embodiments, the additional parts or units may be added into each of the systems, or one or more of the parts or units may be removed from the systems (e.g. LiDAR or radar as shown in FIG. 1).

As mentioned above, service discovery plays a very important role in the automatic driving system. According the implementations, the service discovery is divided into two modes including centralized service discovery and decentralized service discovery.

The centralized service discovery is mainly used in an open source system ROS in which there is a master node used as a central node of the service discovery to manage the entire system. The other automatic driving system may adopt a decentralized service discovery mode due to the fact that there is no central node in the decentralized service discovery itself, so that the entire system is higher in fault tolerance, and entire system breakdown caused by accidental breakdown of the central node may be avoided. By using the technical solution of the decentralized service discovery, the robustness of the entire system is improved, but the existence of a fraud node is not taken into account. For example, consensus protocols in some service discovery are designed on the basis of RAFT, but RAFT itself only allows nodes in the system to crash, and the situation that there are fraud nodes in the system is not taken into account.

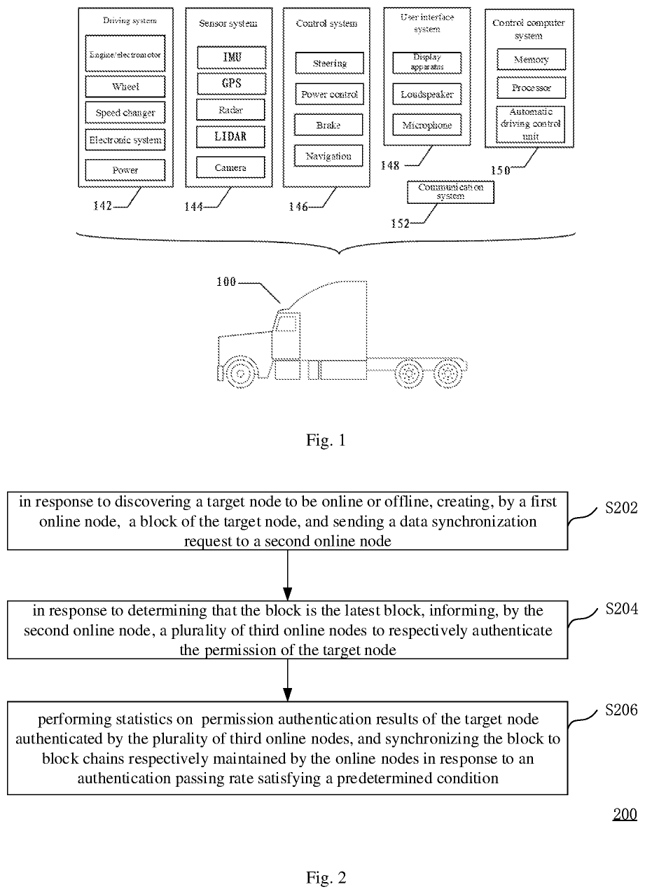

In order to solve the above-mentioned problems, the present disclosure provides a novel service discovery method 200 which may be applied to an automatic driving system. As shown in FIG. 2, the method 200 comprises:

step S202, in response to discovering a target node to be online or offline (i.e., comes online or goes offline), a block of the target node is created, by a first online node, and a data synchronization request is sent to a second online node.

Step S204, in response to determining that the block is the latest block, a plurality of third online nodes are informed, by the second online node, to respectively authenticate the permission of the target node. Each third online node authenticate the permission of the target node to obtain a corresponding permission authentication result, the result comprising authentication passing and authentication failure.

Step S206, statistics is performed on permission authentication results of the target node authenticated by the plurality of third online nodes, to obtain the authentication passing rate, and the block is synchronized to block chains respectively maintained by the current online nodes in response to an authentication passing rate satisfies a predetermined condition. The authentication passing rate is the times of authentication passing divided by the times of total authentications. The online nodes comprise the first node, the second node and the plurality of third online nodes.

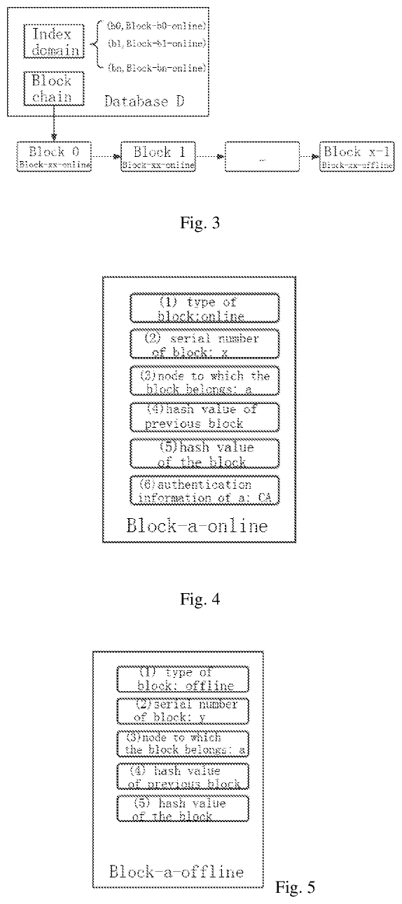

In some embodiments, each node in the present disclosure maintains one database, and the database may be configured to store the current block chain and index domain, a storage structure thereof is shown in FIG. 3 according to an embodiment of the present application, that is, each node co-maintains the same block chain and the same index domain.

Blocks in the block chain are divided into online blocks Block-xx-online and offline blocks Block-xx-offline, wherein Block represents a block, xx represents a serial number of a node to which the block belongs, online represents that a block is online, and offline represents that a block is offline. The online blocks are configured to record online information of the nodes, and the offline blocks are configured to record offline information of the nodes. Information contents of the online blocks and the offline blocks are respectively shown in FIG. 4 and FIG. 5, and each of the blocks comprises at least one of following information: a type of the block, a serial number of the block, a serial number of a node to which the block belongs, a hash value of a previous block, a hash value of the present block, and a data signature of the target node.

The type of the block comprises the online blocks and the offline blocks, the serial number of the block is the number of the blocks in the current block chain plus one, and the serial number of the node to which the block belongs is a serial number of the target node which is discovered to be online or offline. It is assumed that the number of the blocks of the block chain stored in the current database is x−1, a serial number of a newly created block is x. If the target node discovered to be online or offline is node a, the serial number of the node-a to which the block belongs is a. The hash value of the previous block is the hash value of the block x−1 in the block chain, and the hash value of the current block is the hash value of the newly created block x. The hash value may be calculated according to data contents in the blocks and is no limited thereto at present. The hash values of the previous block and the current block in the block chain ensure the characteristic that the blocks in the block chain cannot be modified.

The index domain is of a dictionary structure and comprise at least one index entry, and each index entry of the index domain records a position index of each online block corresponding to each online node. It is assumed that an online node set is B including online nodes b0, b1, . . . , bn, each online node bx (x=0, 1, . . . , n) has an index thereof to the online block Block-bx-online thereof. Index information of an online node can be only put in the index domain, but an index of an offline node may be deleted from a dictionary of the index domain. That is, the index domain only records the index entry of each node in the current online node set.

Generally, when a new node is online (i.e., comes online), a data writing-in request may be initiated; but the node may go offline due to exit by accident, and therefore, the data writing-in request may not be initiated. Therefore, in the embodiment of the present disclosure, the recognition of online of the target node is based on a node online request, but recognition of the offline of the target node is based on heartbeat connection of a heartbeat system.

Specifically, in some embodiments, the step that the first online node discovering the target node to be online in step S202 comprises: the first online node passes, according to the data signature of the target node, the authentication for a node online request sent by the target node.

One data signature comprises two parts: the first part of data is transmitted data (i.e. signed data), and the data may be any data (a segment of binary code) intended to be sent to other nodes, e.g. an IP address and a port number; and the second part of data is new data (a new binary code) obtained after the first part of data is encrypted by using a private key itself. The authentication means that node b authenticates the identity of node a, node b has a public key of node a, and it needs to authenticate that node a comprises a private key of node a. An authentication method is that: firstly, node b receives a data signature from node a; then, the second part of data of the data signature is decrypted by using the public key of node a, and the decrypted data is matched with the first part of data; if they are matched successfully, it is affirmed that the second part of data is encrypted by the private key of node a, and then, it is affirmed that node a has the private key of node a.

Herein, a developer may firstly define an authentication rule for nodes which may be added into a system and form a configuration file. This rule decides the action range of the entire service discovery system. For example, it may be defined, by a user, that nodes having specific identities are only allowed to be added into the system, at the moment, public keys of all nodes which may be added into the system are required to be prestored, and the nodes including corresponding private keys may be added into the system only by initiating the authentication. Therefore, each online node in the current online node set may directly obtain a public key of a node which can be added into the system.

In some other embodiments, in step S202, it is discovered, by the first online node, that the target node is offline (i.e., goes offline), which comprises: the first online node receives the heartbeat information of the target node overtime. The behavior that the node is offline is not necessarily an active behavior, and it is possible that the node exits by accident, at the moment, the node itself cannot ensure that a request is written into the database initiating that the node is offline. At the moment, a heartbeat system is required to take part in affirming whether the node is offline. After the target node is online (i.e., comes online), each node of the online node set may continuously monitor heartbeat information of the target node in a heartbeat way; if heartbeat data of node a is still not received after certain node b is overtime, it may consider that node-a is offline; then, node-b may initiate a request for writing data that node a is offline to the database; and after all nodes greater than or equal to a predetermined proportion (⅓) initiate the request, the request is regarded to be established or to come into effect, then, the request is written into the database, and the nodes are considered to be offline after the request is successfully written.

In some embodiments, the data synchronization request sent by the first online node carries the serial number of the block created by the first online node and the data signature of the target node. In this way, in step S204, the second online node may determine, according to the serial number of the block in the data synchronization request, whether the current block is the latest block, specifically, it may be compared with the largest serial number of the block in the block chain in the database of the second online node (i.e. the number of the blocks), if the serial number of the block in the data synchronization request equals to the largest serial number of the block in the block chain plus one, it is proven that the block is the latest block. For example, it is assumed that the largest serial number of the block in the current block chain is x−1, and the serial number of the block created by the first online node is x, it is proven that the block is the latest block, and a plurality of second online nodes are informed to authenticate the block. If the block is not the latest block, the block is discarded.

It needs to be noted that the second online nodes may be any nodes except the first online node in the online node set and may be understood as central nodes required in a PBFT consensus algorithm, however, the entire service discovery system is a decentralized system and is provided with specially disposed central nodes. From the perspective of target node A, a response to an online request initiated by target node A may be made by any node in the system.

In some embodiments, the second online node is a specified node in the plurality of third online nodes, and the specified node may be any node selected from the third online nodes. At the moment, consensus nodes in the system comprise the first online node and the plurality of third online nodes, and the authentication passing rate=(the number of times that the authentication performed by the third online nodes is passed+1)/(the number of the third online nodes+1). 1 in the equation corresponds to the first online node which has been authenticated. The initial number of times that the authentication is passed is 0, and the number of times that the authentication is passed is increased by 1 every time when the authentication performed on the data signature of the target node by one of the third online nodes according to the public key of the target node is passed. Or the number of times that the authentication is passed is increased by 1 every time when one of the third online nodes is overtime and does not receive the heartbeat information of the target node. It should be understood, by the skilled in the art, that the consensus nodes performing the consensus algorithm may be all nodes in the online node set in the current index, and may also be parts of the nodes in the online node set. Therefore, the plurality of third online nodes may be all or parts of nodes except the first online nodes in the online node set.

In some other embodiments, the second online node is different from the plurality of third online nodes, at the moment, the consensus nodes in the system comprise the first online node, the second online node and the plurality of third online nodes. The plurality of third online nodes may be all or parts of nodes except the first online node and the second online node in the online node set. In step S204, if it is determined, by the second online node, that the block is the latest block, the plurality of third online nodes are informed to respectively authenticate the permission of the target node, which comprises: if it is determined, by the second online node, that the block is the latest block, and the authentication for the permission of the target node is passed, the plurality of third online nodes are informed to respectively authenticate the permission of the target node. That is, after the authentication performed on the permission of the target node by the second online node is passed, the plurality of third online nodes are informed to perform authentication. The passing of the authentication for the permission that the node is online may mean the passing of the authentication for the data signature of the target node, and the passing of the authentication that the node is offline may mean that the heartbeat information of the target node is not received due to overtime. At the moment, the authentication passing rate=(the number of times that the authentication performed by the third online nodes is passed+2)/(the number of the plurality of third online nodes+2). 2 in the equation corresponds to the first online node and the second online node which have passed the authentications.

That is, in step S204, the plurality of third online nodes authenticate the permission of the target node, which comprises: the plurality of third online nodes authenticate, according to the public key and the data signature of the target node, the permission that the target node is online; or the plurality of third online nodes authenticate, according to the heartbeat connection with the target node, the permission that the target node is offline, and if a predetermined proportion of third online nodes are all overtime and do not receive the heartbeat information of the target node, that is, the heartbeat connection between the predetermined proportion of third online nodes and the target node is overtime, it is determined that the target node is offline.

It should be understood that a plurality of target nodes may be online or offline at any moment in the system, and it is also discovered, by a plurality of first online nodes, that the plurality of target nodes are online or offline. Therefore, step S202 further comprises:

in response to a plurality of first online nodes discovering at the same time, that the target node is online or offline, each first online node creates the block of the target node and sends a data synchronization request to the second online node; and

in response to a plurality of first online nodes discovering at the same time, that a plurality of target nodes are online or offline, each first online node creates block of the discovered target node and sends a data synchronization request to the second online node.

Each data synchronization request carries the serial number of the created block and the data signature of the target node. A plurality of data synchronization requests may be sent to the second online nodes for responding processing. The second online node processes the plurality of data synchronization requests in order according to arrival time or sending time of each data synchronization request and temporarily stores unprocessed data synchronization requests into a cache area. Herein, the second online node determines the processing order of the plurality of data synchronization requests and performs the operation of authenticating each block in sequence, for example, it is only recognized whether the block is the latest block, or not only is it recognized whether the block is the latest block, but also the data signature of the target node is authenticated. If the authentication is passed, the plurality of third online nodes are informed to authenticate the permission of the target node, that is, consensus authentication performed on the target node by the consensus nodes is initiated. If the authentication is not passed, the block is discarded, and the next data synchronization request is selected from the cache area for processing.

In some embodiments, the second online node may initiate the next consensus response in response to consensus results of all the online nodes having been obtained, that is, each consensus node is informed to perform consensus authentication. Each online node authenticates the permission of the target node comprising authenticating the data signature of the target node according to the public key of the target node.

If the authentication passing rates of all the online nodes satisfy the predetermined condition, it is determined that the target node is a normal node, and all the online nodes add the block of the target node into the block chains of the respectively databases. If the authentication passing rates do not satisfy the predetermined condition, it is determined that the target node is an abnormal node, and the block is discarded. In this way, the blocks in the block chain are always the blocks authenticated by the consensus nodes. Wherein the authentication passing rates satisfy the predetermined condition, for example, the authentication passing rate reaches a predetermined value (e.g. ⅓, of course, not limited thereto).

It is known that each of the current online nodes co-maintains the same block chain, the number of blocks in the block chain (i.e. the largest serial number of the current block) is x−1, if it is discovered, by m first online nodes at the same time, that the target node a is online, each first online node creates a block of the target node a (the serial numbers of the created blocks are all x) and respectively initiates a data synchronization request to the second online node. The second online node may process these data synchronization requests according to arrival time or sending time of these data synchronization requests, an earliest response may be made to data synchronization request 1 arriving firstly and including the serial number x of the block, and other data synchronization requests 2−m may be stored into a cache area.

The second online node compares the serial number x of the block in the data synchronization request with the largest serial number of the block in the block chain to determine that the block is the latest block. Then, if the block is authenticated by the consensus algorithm, the block may be connected to the block chain of each online node, and the largest serial number of the block is updated to be x.

Hereafter, if the second online node selects other data synchronization requests 2−m from the cache area for processing, it will be discovered that the serial numbers of these blocks are all the same as the largest serial number of the current block chain, which means that these blocks are not the latest blocks, and therefore, they will be discarded.

On the other aspect, if the block of data synchronization request 1 does not pass the authentication by the consensus algorithm, the block may also be discarded, and the second online node further selects data synchronization request 2 to be processed until a block of which the serial number is x is added into the block chain.

Similarly, if it is discovered, by a plurality of first online nodes at the same time, that a plurality of target nodes are online or offline, each first online node creates online block or offline block of the discovered target node and sends a data synchronization request. For example, if it is discovered, by first online node 1, that target node 1 is online, and it is discovered, by first online node 2, that target node 2 is offline, first online node 1 creates online block 1 of target node 1, wherein the serial number of the block is x; and first online node 2 creates offline block 2 of target node 2, wherein the serial number of the block is x. The second online node performs processing according to the arrival order of the two data synchronization requests, and if the data synchronization request of first online node 1 arrives firstly, the data synchronization request of first online node 1 is processed firstly. If the block in the request is authenticated by the consensus algorithm, the block may be added, by online block 1, into the block chain co-maintained by each online node, and the serial number of the latest block in the block chain becomes x.

When the second online node further processes the data synchronization request sent by first online node 2, it will be discovered that offline block 2 is not the latest block, and therefore, offline block 2 may be discarded, that is, there is no successful response to the situation that target node 2 is offline. At the moment, one or more other first online nodes may further make a response to the situation that target node 2 is offline to generate a new offline block of which the serial number is x+1. The second online node further processes these data synchronization requests including the serial number x+1 of the block, and the offline block of which the serial number is x+1 will be connected to the block chain after the authentication performed according to the consensus algorithm is successful.

In such a way, online block 1 of which the serial number is x and the offline block of which the serial number is x+1 are added into the block chain, so that it is ensured that a corresponding block is added into the block chain when a node passing the authentication is online or offline.

In some embodiments, the method 200 may further comprise the step that: if the first online node discovers a situation that the target node is online, and the authentication passing rate satisfies the predetermined condition, an index entry of the target node is added into index domains of all the current online nodes, and the updated index domain and updated block chain are synchronized into the database of the target node. Herein, after it is determined, by the online node set, that the target node is online successfully, the block chains and index domains of other existing online nodes may be updated (the online block of the target node is newly added in the block chain to obtain a updated/latest block chain, and the index of the target node is newly added in the index domain to obtain a updated/latest index domain), and the target node may also acquire the latest block chain and index domain.

In some other embodiments, the method 200 may further comprise the steps: if the first online node discovers a situation that the target node is offline, and the authentication passing rate satisfies the predetermined condition, the index entry of the target node is deleted from the index domains of all the current online nodes, and the block chain and the index domain stored in the database of the target node are deleted. Herein, after it is determined, by the online node set, that the target node is offline successfully, the block chains and index domains of the current existing online nodes may be updated (the offline block of the target node is newly added in the block chain, and the index of the target node is deleted from the index domain), and the block chain and the index domain maintained in the database of the target node may also be deleted.

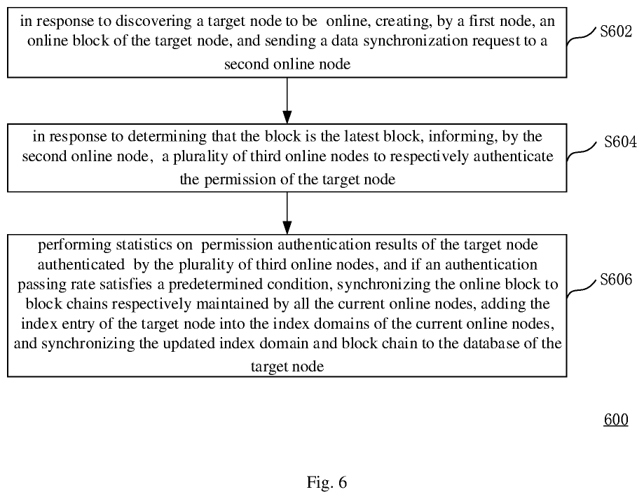

FIG. 6 shows a service discovery method 600 for a situation that a node is online according to an embodiment of the present disclosure. As shown in FIG. 6, the method 600 comprises:

step S602, in response to a first online node discovering a target node to be online, an online block of the target node is created, by a first online node, and a data synchronization request is sent to a second online node;

step S604, in response to the second online node determining that the online block is the latest block, a plurality of third online nodes are informed, by the second online node, to respectively authenticate the permission of the target node to obtain a corresponding permission authentication result of the target node; and

step S606, statistics is performed on permission authentication results of the target node authenticated by the plurality of third online nodes, and if an authentication passing rate satisfies a predetermined condition, the online block is synchronized to block chains respectively maintained by all the current online nodes, the index entry of the target node is added into the index domains of all the current online nodes, and the updated index domain and block chain are synchronized to the database of the target node.

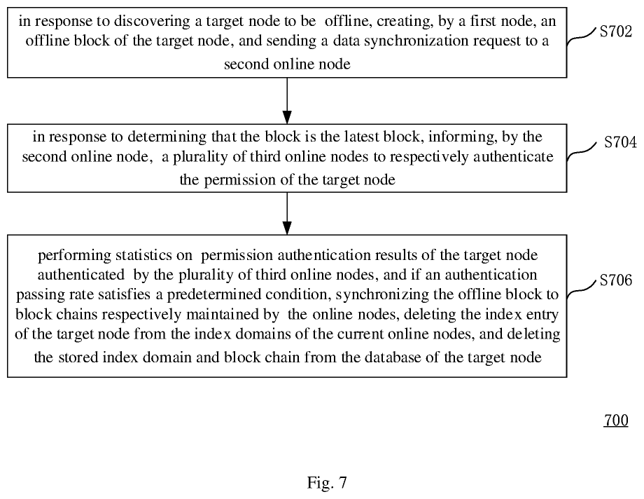

FIG. 7 respectively shows a service discovery method 700 for a situation that a node is offline according to an embodiment of the present disclosure. As shown in FIG. 7, the method 700 comprises:

step S702, in response to a first online node discovering a target node to be offline, an offline block of the target node is created, by a first online node, and a data synchronization request is sent to a second online node;

step S704, in response to the second online node determining that the offline block is the latest block, a plurality of third online nodes are informed, by the second online node, to respectively authenticate the permission of the target node; and

step S706, statistics is performed on permission authentication of the target node authenticated by the plurality of third online nodes, and if an authentication passing rate satisfies a predetermined condition, the offline block is synchronized to block chains respectively maintained by all the current online nodes, the index entry of the target node is deleted from the index domains of all the current online nodes, and the stored index domains and block chains are deleted from the database of the target node.

The processes that nodes are online and offline will be described below with specific examples:

1, a process that target node a is online:

1) when target node a is started, an authentication module (a public key and a private key of node a and a configuration file), a communication module and a data storage module are loaded. The private key is saved by oneself and is used as a basis for identity authentication, the public key may be sent to a system, and a node in any system may acquire the public key. Of course, if other nodes also load the configuration file, they have owned the public key of target node a, and therefore, it is unnecessary to additionally send the public key.

2) In response to the loading of the communication module of target node a being completed, a specific network port will be monitored to monitor data of other nodes on a network is monitored, and an online request CA itself is continuously sent to network ports monitored by other nodes. The network port may be monitored by all nodes in an online node set B (b0, b1, . . . bn). The online request CA of target node a is a data signature of which the content comprises a first part of data: an IP address to which the data signature belongs and other communication link information (the content of the part of information is related to a specifically used communication module). Communication may be established between each of other nodes and the communication module of node a through the first part of content in the data signature.

3) In response to first online node b (node b belongs to set B and may be any node in set B) monitoring the online request CA of target node a, firstly, a legal identity of target node a is affirmed by the authentication module, if the authentication is passed, a new block Block-a-online is created, and a request for synchronizing database D is continuously initiated. A structure of the block Block-a-online is shown in FIG. 4. If the authentication is not passed, a management module may be informed to force node a to be offline.

4) In response to a request for adding the block Block-a-online and synchronizing database D occurring in the system, a central node (second online node) set in a PBFT consensus algorithm may perform response processing (the central node described herein is a leader only required in the PBFT consensus algorithm, the entire system is a decentralized system, and there is no concept of the leader. From the perspective of node a, a response to the online request initiated by node a may be made by any node b in the system, and there is no situation that a specifically disposed central node makes a response to the request of external node a). In response to the request being responded, other requests may be put into a cache area for later processing.

5) The second online node firstly determines whether the block Block-a-online is the latest block (in order to solve the problem that a plurality of nodes are online at the same time), if the block is not the latest block, the request is directly discarded, and it is determined whether there are still unprocessed requests in the cache area, if yes, the next request is selected from the cache area so as to be processed. If the block is the latest block, each online node may be required to perform identity authentication through the data signature in the Block-a-online, after there are no errors in the authentication performed by more than ⅓ of nodes, the blocks in all the nodes are synchronized once by using the PBFT consensus algorithm, after the synchronization, each node in the system may add the block Block-a-online into the block chain of database D and add the index entry of target node a into the index domain.

2. A situation that target node a is offline:

1) first online node b (any node belonging to online node set B) may continuously monitor heartbeat information of target node a in a heartbeat way, and in response to an overtime heartbeat connection being discovered, a new block Block-a-offline may be created, and a request for synchronizing database D is initiated. A structure of the Block-a-offline is shown in FIG. 5 (it is assumed that the number of blocks in the current block chain is y−1).

2) In response to a request for adding the block Block-a-offline and synchronizing database D occurring in the system, a second online node set in a PBFT consensus algorithm may perform response processing. In response to the response being affirmed to be responded, other requests may be put into a cache area for later processing.

3) The second online node firstly determines whether the Block-a-online is the latest block, if the block is not the latest block, the request is directly discarded, and the next request is selected from the cache area so as to be processed. If the block is the latest block, each online node may be required to affirm the situation that node a is offline (through a heartbeat overtime mechanism), in response to more than ⅓ of nodes confirming the offline authentication, the blocks in all the nodes are synchronized once by using the PBFT consensus algorithm, after the synchronization, each node in the system may add the Block-a-online into the block chain of database D.

4) In response to latest block chains of all the nodes (b0, b1, . . . , bn) having been updated, an entry (a, Block-a-online) is deleted from the index domain, at the moment, node a is also excluded from the system, and a process that node a is offline is also declared to be ended.

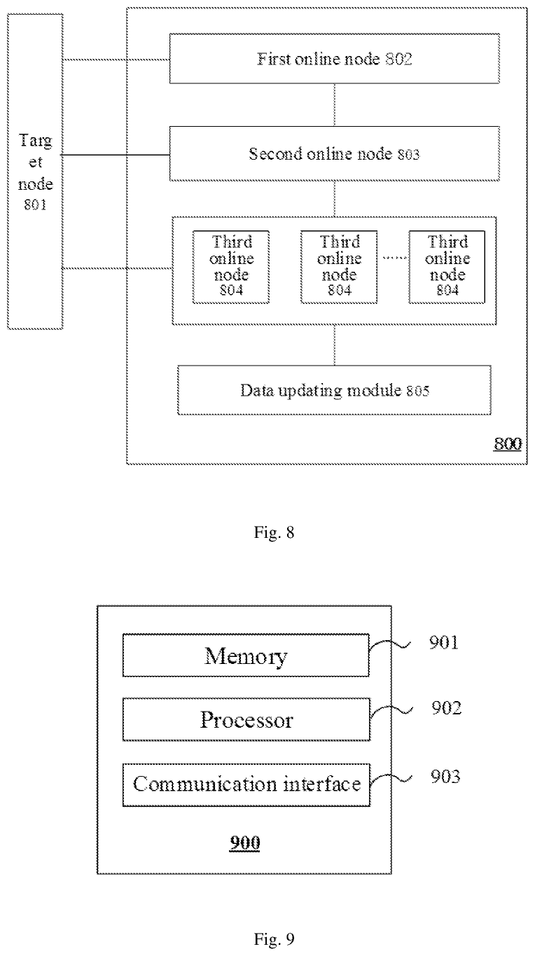

FIG. 8 is a structural diagram of a service discovery apparatus 800 according to an embodiment of the present disclosure. As shown in FIG. 8, the system 800 comprises a first online node 802, a second online node 802, a plurality of third online nodes 803, and a data updating module 805.

A first online node 802 is configured to create a block of a target node in response to discovering that the target node 801 is online or offline;

a second online node 803 configured to, in response to a data synchronization request sent by the first online node 802, inform a plurality of third online nodes 804 to respectively authenticate the permission of the target node 801 in response to determining that the block is the latest block; and

data updating module 805 configured to perform statistics on permission authentication results of the target node 801 authenticated by the plurality of third online nodes 804, and synchronize the block to block chains respectively maintained by all the current online nodes if an authentication passing rate satisfies a predetermined condition.

In some embodiments, the system 800 further comprises a database respectively maintained by each node. The database is configured to store the current block chain and index domain; and blocks in the block chain are divided into online blocks and offline blocks, the online blocks are configured to record online information of the nodes, and the offline blocks are configured to record offline information of the nodes. Each of the blocks comprises at least one of the following information: a type of the block, a serial number of the block, a serial number of a node to which the block belongs, a hash value of a previous block, a hash value of the present block, and authentication information of the target node, and the type of the block comprises the online blocks and the offline blocks. Each index entry of the index domain comprises an index value of each online node to the online block thereof.

In some embodiments, the data synchronization request carries the serial number of the block; the serial number of the block equals to the number of the blocks in the current block chain of the first online node 802 plus one; and the second online node 803 determines, according to the serial number of the block, whether the block is the latest block.

In some embodiments, if the first online node 802 discovers a situation that the target node 801 is online, and the authentication passing rate satisfies the predetermined condition, the data updating module 805 further adds the index entry of the target node into the index domains of all the current online nodes and synchronizes the updated index domain and block chain to the database to the target node.

In some other embodiments, if the first online node 802 discovers a situation that the target node 801 is offline, and the authentication passing rate satisfies the predetermined condition, the data updating module 805 further deletes the index entry of the target node 801 from the index domains of all the current online nodes and deletes the block chain and the index domain stored in the database of the target node.

In some embodiments, when the authentication performed on the node online request sent by the target node 801 according to the data signature of the target node 801 is passed, it is regarded that the first online node 802 discovers that the target node 801 is online. When the first online node 802 receives the heartbeat information of the target node 801 overtime, it is regarded that the first online node 802 discovers that the target node 801 is offline.

In some embodiments, for a situation that the target node 801 is online, the plurality of third online nodes 804 authenticate the permission of the target node 801 according to a prestored public key of the target node 801; and for a situation that the target node 801 is offline, the plurality of third online nodes 804 authenticate the permission of the target node 801 according to heartbeat connection with the target node.

In some embodiments, in response to a plurality of first online nodes 802 discovering at the same time, that the target node 801 is online or offline, each first online node 802 creates the block of the target node 801 and sends a data synchronization request to the second online node 803; and in response to a plurality of first online nodes 802 discovering at the same time, that a plurality of target nodes 801 are online or offline, each first online node 802 creates block of the discovered target node 801 and sends a data synchronization request to the second online node 803. The second online node 803 processes the plurality of data synchronization requests in order according to arrival time or sending time of each data synchronization request and temporarily stores unprocessed data synchronization requests into a cache area; wherein if it is determined, by the second online node 803, that the block is not the latest block, the block is discarded, and the next data synchronization request is selected from the cache area for processing.

In some embodiments, the second online node 803 is any node in the plurality of third online nodes 804, at the moment, consensus nodes comprise the first online node 803 and the plurality of third online nodes 804. In some other embodiments, the second online node 803 is any node different from the plurality of third online nodes 804, at the moment, the consensus nodes in the system comprise the first online node 802, the second online node 803 and the plurality of third online nodes 804.

In some embodiments, in response to the block being determining that the block is the latest block, the plurality of third online nodes are informed, by the second online node 803, to authenticate the permission of the target node. In some other embodiments, in response to the second online node 803 determining that the block is the latest block and the authentication performed on the target node is passed, the plurality of third online nodes are informed, by the second online node 803, to authenticate the permission of the target node.

The specific details of the service discovery apparatus 800 according to the present disclosure have been disclosed in detail in the description based on other accompanying drawings so as not to be described again herein.

In addition, an embodiment of the present disclosure further provides a computer-readable storage medium including a program or an instruction which, when running on a computer, implements a multi-target tracking method as mentioned above.

In addition, an embodiment of the present disclosure further provides a computing device 900 as shown in FIG. 9, including a memory 901 and one or more processors 902 in communication connection with the memory. The memory 901 stores an instruction which may be executed by the one or more processors 902, and the instruction is executed by the one or more processors 902, so that the one or more processors 902 implement a point cloud processing method as mentioned above. The computing device 900 may further comprise a communication interface 903 which may implement one or more communication protocols (LTE, Wi-Fi, etc.).

According to the technical solutions in the present disclosure, the problem of data falsification and tampering in service node discovery is solved, a signature generated by a private key of a corresponding node is required if online data is falsified, and ⅓ of nodes are required to be subjected to heartbeat affirmation if offline data is falsified. The characteristics of the block chain ensure that each block is difficult to tamper, and if data is intended to be falsified, data on the block chains of more than ⅓ of nodes has to be modified at the same time, and thus, the accuracy of data of the block chains is guaranteed.

It should be understood by the skilled in the art that the embodiments of the present disclosure may provide a method, system or computer program product. Therefore, forms of a complete hardware embodiment, a complete software embodiment or a software and hardware aspect combined embodiment may be adopted in the present disclosure. Moreover, a form of a computer program product executed on one or more computer available storage media (including, but not limited to a magnetic disk memory, a CD-ROM and an optical memory) including computer available program codes may be adopted in the present disclosure.

The present disclosure is described with reference to flow diagrams and/or block diagrams of the method, device (system) and computer program product according to the embodiments of the present disclosure. It should be understood that each flow and/or block in the flow diagrams and/or block diagrams as well as a combination of flows and/or blocks in the flow diagrams and/or block diagrams may be achieved by computer program instructions. The computer program instructions may be provided to a general-purpose computer, a special-purpose computer, an embedded processor or processors of other programmable data processing devices to generate a machine, so that an apparatus for achieving specified functions in one or more flows in the flow programs and/or one or more blocks in the block diagrams is generated through the instructions executed by the computer or the processors of other programmable data processing devices.

These computer program instructions may also be stored in a computer-readable memory capable of guiding the computer or other programmable data processing devices to work in a specific way, so that the instructions stored in the computer-readable memory generate a product including an instruction apparatus, and the instruction apparatus realizes the functions specified in the one or more flows in the flow diagrams and/or one or more blocks in the block diagrams.

These computer program instructions may also be loaded in the computer or other programmable data processing devices, so that a series of operation steps are performed on the computer or other programmable data processing devices to generate processing achieved by the computer, and furthermore, the instructions executed on the computer or other programmable data processing devices provide steps for achieving the specified functions in the one or more flows in the flow diagrams and/or one or more blocks in the block diagrams.

Specific embodiments are used in the present disclosure to describe the principle and implementations of the present disclosure. The descriptions of the foregoing embodiments are merely intended to help understand the method in the present disclosure and the core concept thereof. Meanwhile, the ordinary skill in the art may, based on the concept of the present disclosure, make modifications with respect to the specific implementations and the disclosure scope. In conclusion, the content of the present description should not be understood as a limitation to the present disclosure.

What is claimed is:

1. A service discovery method, comprising:
in response to discovering a target node to be online or offline, creating, by a first online node, a block of the target node, and sending a data synchronization request to a second online node;
in response to determining that the block is a latest block, informing, by the second online node, a plurality of third online nodes to respectively authenticate a permission of the target node to obtain a corresponding permission authentication result; and
determining an authentication passing rate according to the permission authentication results of the plurality of third online nodes; and
synchronizing the block to a block chain respectively maintained by each online node in response to the authentication passing rate satisfying a predetermined condition.

2. The method of claim 1, wherein:
each node maintains a database, and the database is configured to store the block chain; and
blocks in the block chain are divided into online blocks and offline blocks, the online blocks are configured to record online information of the node, and the offline blocks are configured to record offline information of the node.

3. The method of claim 2, wherein:
the database of each node is further configured to store an index domain, the index domain comprises at least one index entry, and the index entry comprises a position index of the online block corresponding to the online node.

4. The method of claim 3, further comprising:
in response to the first online node discovering that the target node is online and the authentication passing rate satisfies the predetermined condition:
adding an index entry of the target node into index domains of the online nodes, and synchronizing a latest index domain and the latest block chain into the database of the target node.

5. The method of claim 3, further comprising:
in response to the first online node discovering that the target node is offline and the authentication passing rate satisfies the predetermined condition:
deleting the index entry of the target node from the index domains of the online nodes, and deleting the block chain and the index domain stored in the database of the target node.

6. The method of claim 1, wherein the block comprises at least one of the following information:
a type of the block, a serial number of the block, a serial number of the node to which the block belongs, a hash value of a previous block, a hash value of the block, and a data signature of the target node, wherein the type of the block comprises an online block and an offline block.

7. The method of claim 1, wherein:
the data synchronization request carries a serial number of the block;
the serial number of the block equals to a number of the blocks in the block chain of the first online node plus one; and
the method further comprises: determining, by the second online node, whether the block is the latest block according to the serial number of the block.

8. The method of claim 1, wherein:
the second online node is a specified node in the plurality of third online nodes; and
the authentication passing rate=(a number of times that the authentication performed by the third online nodes is passed+1)/(a number of third online nodes+1).

9. The method of claim 1, wherein:
discovering the target node to be online comprises: passing, by the first online node according to a data signature of the target node, the authentication for a node online request sent by the target node;
discovering the target node to be offline comprises: receiving, by the first online node, the heartbeat information of the target node overtime.

10. The method of claim 1, wherein: the first online is a plurality of first online nodes, the method further comprises:
in response to the plurality of first online nodes discovering at a same time the target node to be online or offline:
creating, by each of the plurality of first online nodes, the block of the target node, and sending a data synchronization request to the second online node.

11. The method of claim 10, wherein: the target node is a plurality of target nodes, the method further comprises:
in response to the plurality of first online nodes discovering at the same time the plurality of target nodes to be online or offline:
creating, by each of the plurality of first online nodes, the block of the corresponding discovered target node, and sending a data synchronization request to the second online node.

12. The method of claim 10, further comprising:
processing, by the second online node, a plurality of data synchronization requests in order according to arrival time of the data synchronization requests and temporarily stores unprocessed data synchronization requests into a cache area; and
in response to the block not being the latest block, discarding the block, by the second online node, and selecting an unprocessed data synchronization request from the cache area for processing.

13. The method of claim 1, wherein the method further comprises:
authenticating, by the plurality of third online nodes, the permission of the target node according to a prestored public key of the target node if the target node is online; and
authenticating, by the plurality of third online nodes, the permission of the target node according to heartbeat connection with the target node if the target node is offline.

14. A computing device, comprising:
a processor, a memory, and a computer program stored in the memory and executable on the processor;
wherein the processor, when executing the computer program, implements a method comprising:
in response to discovering a target node to be online or offline, creating, by a first online node, a block of the target node, and sending a data synchronization request to a second online node;
in response to determining that the block is a latest block, informing, by the second online node, a plurality of third online nodes to respectively authenticate a permission of the target node to obtain a corresponding permission authentication result; and
determining an authentication passing rate according to the permission authentication results of the plurality of third online nodes; and
synchronizing the block to a block chain respectively maintained by each online node in response to the authentication passing rate satisfying a predetermined condition.

15. The computing device of claim 14, wherein:
each node maintains a database, and the database is configured to store the block chain; and
blocks in the block chain are divided into online blocks and offline blocks, the online blocks are configured to record online information of the node, and the offline blocks are configured to record offline information of the node.

16. The computing device of claim 15, wherein:
the database of each node is further configured to store an index domain, the index domain comprises at least one index entry, and the index entry comprises a position index of the online block corresponding to the online node.

17. The computing device of claim 16, wherein the method further comprises:
in response to the first online node discovering that the target node is online and the authentication passing rate satisfies the predetermined condition:
adding an index entry of the target node into index domains of the online nodes, and synchronizing a latest index domain and the latest block chain into the database of the target node.

18. A non-transitory computer-readable storage medium storing a computer program, the computer program, when executed by a processor, implementing a method comprising:
in response to discovering a target node to be online or offline, creating, by a first online node, a block of the target node, and sending a data synchronization request to a second online node;
in response to determining that the block is a latest block, informing, by the second online node, a plurality of third online nodes to respectively authenticate the permission of the target node to obtain a corresponding permission authentication result; and
determining an authentication passing rate according to a permission authentication results of the plurality of third online nodes; and
synchronizing the block to a block chain respectively maintained by each online node in response to the authentication passing rate satisfying a predetermined condition.

19. The non-transitory computer-readable storage medium of claim 18, wherein:
discovering the target node to be online comprises: passing, by the first online node according to a data signature of the target node, the authentication for a node online request sent by the target node;
discovering the target node to be offline comprises: receiving, by the first online node, a heartbeat information of a target node overtime.

20. The non-transitory computer-readable storage medium of claim 18, wherein: the first online is a plurality of first online nodes, the method further comprises:
in response to the plurality of first online nodes discovering at a same time the target node to be online or offline:
creating, by each of the plurality of first online nodes, the block of the target node, and sending a data synchronization request to the second online node.
